(19) United States
(12) Patent Application Publication
(10) Pub. No.: US 2026/0236724 A1
(43) Pub. Date: Aug. 13, 2026

(54) IDENTIFYING RFID TAG FEATURES FROM TAG REPLY

(71) Applicant: Impinj, Inc., Seattle, WA (US)

(72) Inventors: Christopher J. DIORIO, Shoreline, WA (US); Rene Dominic MARTINEZ, Seattle, WA (US); Matthew ROBSHAW, Seattle, WA (US)

(73) Assignee: Impinj, Inc., Seattle, WA (US)

(21) Appl. No.: 19/635,658

(22) Filed: Mar. 31, 2026

Related U.S. Application Data
(63) Continuation of application No. PCT/US25/40560, filed on Aug. 4, 2025.
(60) Provisional application No. 63/679,226, filed on Aug. 5, 2024.

(51) Int. Cl. G06K 7/10; H04B 5/77

(52) U.S. Cl. CPC G06K 7/10366; H04B 5/77

(57) ABSTRACT

A method to identify a manufacturer of a radio IC and one or more features of the radio IC is provided. The radio IC may be configured with at least two operating states. If the radio IC is in a first state, then the radio IC may respond to inventorying commands with a collision-resolution code uncorrelated to any radio IC information. If the radio IC is in a second state, then the radio IC may respond to inventorying commands with a special collision-resolution code correlated to some radio IC information and computed using a generation process known to the tag and the reader. The reader may then send an acknowledgement command, and the radio IC may respond by providing an identifier to the reader.

### CROSS REFERENCE TO RELATED APPLICATIONS

This application claims priority to U.S. Provisional Patent Application Ser. No. 63/679,226 filed on Aug. 5, 2024. The disclosures of the Provisional Application are hereby incorporated by reference in their entirety.

### BACKGROUND

Radio-Frequency Identification (RFID) systems typically include RFID readers, also known as RFID reader/writers or RFID interrogators, and RFID tags, also known as radio tags. RFID systems can be used in many ways for locating and identifying objects to which the tags are attached. RFID systems are useful in product-related and service-related industries for tracking objects being processed, inventoried, or handled. In such cases, an RFID tag is usually attached to an individual item, or to its package. The RFID tag typically includes, or is, a radio-frequency (RF) integrated circuit (IC). Such an RFIC may be referred to as an RFID IC or a radio IC.

In principle, RFID techniques entail using an RFID reader to inventory one or more RFID tags, where inventorying involves singulating a tag, receiving an identifier from a tag, and/or acknowledging a received identifier (e.g., by transmitting an acknowledge command). “Singulated” is defined as a reader singling-out one tag, potentially from among multiple tags, for a reader-tag dialog. “Identifier” is defined as a number identifying the tag or the item to which the tag is attached, such as a tag identifier (TID), electronic product code (EPC), etc. An “inventory round” is defined as a period during which a reader stages RFID tags for successive inventorying. The reader transmitting an RF wave performs the inventory. The RF wave is typically electromagnetic, at least in the far field. The RF wave can also be predominantly electric or magnetic in the near or transitional near field. The RF wave may encode one or more commands that instruct the tags to perform one or more actions. The operation of an RFID reader sending commands to an RFID tag is sometimes known as the reader “interrogating” the tag.

In typical RFID systems, an RFID reader transmits a modulated RF inventory signal (a command), receives a tag reply, and transmits an RF acknowledgement signal responsive to the tag reply. A tag that replies to the interrogating RF wave does so by transmitting back another RF wave. The tag either generates the transmitted back RF wave originally, or by reflecting back a portion of the interrogating RF wave in a process known as backscatter. Backscatter may take place in a number of ways.

Tag manufacturers can include various features and capabilities into RFID tags that can provide additional capabilities not included in standard communication protocols. An RFID reader can take advantage of the additional features, but must first be aware of the additional capabilities of the RFID tags. Improvements to identify the features of a tag are desirable.

### BRIEF SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to a method for a radio integrated circuit having an identifier and configured to operate in a first state or a second state. The method may include the tag receiving an inventorying command. If the radio IC is in the first state, then the radio IC may respond to the inventorying command by sending a first reply including a first random number. The first reply may be uncorrelated with the identifier. If the radio IC is in the second state, then the radio IC may respond to the inventorying command by sending a second reply including a second random number. The second reply may be correlated with the identifier. The method may also include receiving an acknowledgement command including either the first or second reply, and responding to the acknowledgement command by sending the identifier.

Other embodiments are directed to a method for a radio frequency identification reader. The method may include the reader transmitting a request including an inventorying command and requesting a correct radio tag reply that includes a random number to a radio tag. A correct radio tag reply may be at least partly formed by a tag reply computation using a portion of a radio tag identifier and one or more of: at least a portion of the random number, and a portion of the inventorying command. The method may also include receiving, from the radio tag, a reply and an identifier. The method may also include determining, using at least the tag reply computation and the received identifier, whether the received reply is correct. If the received reply is not correct, then the method can include at least one of: not reporting the radio tag to an application, and reporting the radio tag as inappropriate or counterfeit to the application.

Additional embodiments are directed to a method for a radio frequency identification reader to report radio tags that support collision resolution (CR) reply computation to an application. The method may include the reader transmitting a request including an inventorying command and requesting a CR reply to a radio tag. The method may also include receiving, from the radio tag, a CR reply and an identifier. The method may further include determining whether the CR reply is correlated with the identifier. If the CR reply is correlated with the identifier, the method may include reporting the radio tag to the application. If the CR reply is not correlated with the identifier, the method may include at least one of: reporting the radio tag as inappropriate or counterfeit to the application, and determining that the radio tag does not support the CR reply computation.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The following Detailed Description proceeds with reference to the accompanying drawings, in which:

FIG. 1 is a block diagram of components of an RFID system.

FIG. 2 is a diagram showing components of a passive RFID tag, such as a tag that can be used in the system of FIG. 1.

FIG. 3 is a conceptual diagram for explaining a half-duplex mode of communication between the components of the RFID system of FIG. 1.

FIG. 4 is a block diagram showing a detail of an RFID tag, such as the one shown in FIG. 2.

FIGS. 5A and 5B illustrate signal paths during tag-to-reader and reader-to-tag communications in the block diagram of FIG. 4.

FIG. 6 is a block diagram showing a detail of an RFID reader system, such as the one shown in FIG. 1.

FIG. 7 is a diagram of an example RFID tag IC memory configuration, according to embodiments.

FIG. 8 is a process flow diagram of a reader inventorying a tag IC configured to modify its reply, according to embodiments.

### DETAILED DESCRIPTION

In the following detailed description, references are made to the accompanying drawings that form a part hereof, and in which are shown by way of illustration specific embodiments or examples. These embodiments or examples may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

As used herein, “memory” is one of ROM, RAM, SRAM, DRAM, NVM, EEPROM, FLASH, Fuse, MRAM, FRAM, and other similar volatile and nonvolatile information-storage technologies. Some portions of memory may be writeable and some not. “Instruction” refers to a request to a tag to perform a single explicit action (e.g., write data into memory). “Command” refers to a reader request for one or more tags to perform one or more actions, and includes one or more tag instructions preceded by a command identifier or command code that identifies the command and/or the tag instructions. “Program” refers to a request to a tag to perform a set or sequence of instructions (e.g., read a value from memory and, if the read value is less than a threshold then lock a memory word). “Protocol” refers to an industry standard for communications between a reader and a tag (and vice versa). One such protocol is the Class-1 Generation-2 UHF RFID Protocol for Communications at 860 MHz-960 MHz by GS 1 EPCglobal, Inc. (“the Gen 2 Protocol”), versions up to 3.0 of which are hereby incorporated by reference. Another protocol is the ISO/IEC 18000-63 Information technology—Radio frequency identification for item management—Part 63: Parameters for air interface communications at 860 MHz to 960 MHz Type C (“ISO/IEC 18000-63”), also hereby incorporated by reference.

A manufacturer of radio tag ICs may manufacture tag ICs with various features and capabilities. Often, tag ICs are manufactured such that they can operate according to a protocol, such as the above referenced Gen2 Protocol and/or ISO/IEC 18000-63. However, tags may be configured to support certain optional features specified within such protocols, or may even support other features. While an RFID reader may be able to identify such features or capabilities as a part of a protocol-based inventorying process, the identification process may require additional steps or prolong the inventorying process.

For example, in the Gen2 Protocol, a reader may initiate an inventory round by transmitting an inventorying command. Gen2 inventorying commands, also referred to as “inventory commands,” may include the Query, Query X, Query Y, Query Adjust, QueryRep, ACK, and NAK commands. A tag IC may participate in the inventory round and reply to the inventorying command with a collision-resolution (CR) code that allows the reader to resolve collisions, which occur when multiple tag ICs reply to an inventorying command at the same time. For example, a CR code may include a random or pseudorandom 16-bit number called an RN16. The reader may thereafter acknowledge the tag reply with the provided CR code (for example, via a Gen2 ACK command), and the tag IC may then respond with an identifier, such as its electronic product code (EPC). This identifier generally provides information about any items associated with the tag IC but not about the tag IC itself. After receiving the identifier, the reader may then either (a) inventory another tag IC, or (b) optionally perform additional operations related to the current tag IC. For example, the reader may read additional data from the current tag IC's memory, such as its tag identifier (TID), which can provide information about the tag IC itself, such as its manufacturer and/or features of the tag IC. In this approach, the reader must perform the optional step (b) to determine information about a tag IC itself, because preceding tag replies to inventorying commands generally do not convey such information. This optional step slows down the inventorying process, because otherwise the reader could be inventorying other tag ICs.

Modifications to how tag ICs respond in the inventorying process, described herein, allow a reader to gather additional information about a tag or tag IC, such as its manufacturer, features, or capabilities, without significantly delaying the inventorying process. One such modification can include configuring a tag to reply with a special collision-resolution (CR) code that is a value computed based on (a) some random or pseudorandom number and (b) other information known to the tag and provided to the reader, such as an electronic product code (EPC) of the tag or something at least partly derived from the EPC. When inventorying tags, a reader may receive a CR code and an EPC in response to inventorying commands. After receiving both the CR code and the EPC, the reader may determine whether the CR code is a special CR code computed based on the EPC. If the reader determines that the received CR code is a special CR code, then the reader (or some associated entity) knows that the tag is capable of generating special CR codes. Based on that knowledge, the reader or entity may be able to determine a manufacturer and/or features of the tag or tag IC, which may enable the reader or entity to perform additional tasks.

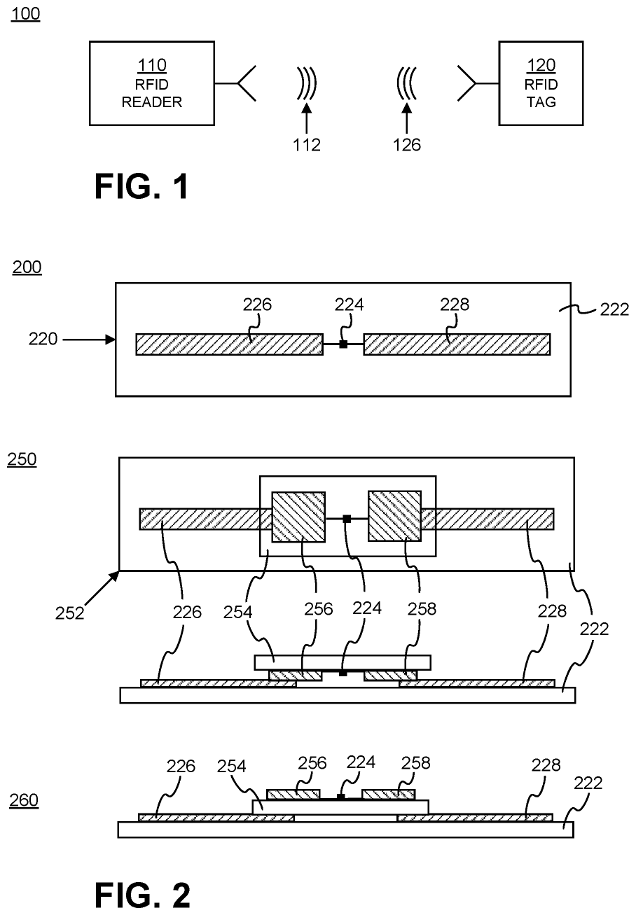

FIG. 1 is a diagram of the components of a typical RFID system 100, incorporating embodiments. An RFID reader 110 and a nearby RFID tag 120 communicate via RF signals 112 and 126. When sending data to tag 120, reader 110 may generate RF signal 112 by encoding the data, modulating an RF waveform with the encoded data, and transmitting the modulated RF waveform as RF signal 112. In turn, tag 120 may receive RF signal 112, demodulate encoded data from RF signal 112, and decode the encoded data. Similarly, when sending data to reader 110 tag 120 may generate RF signal 126 by encoding the data, modulating an RF waveform with the encoded data, and causing the modulated RF waveform to be sent as RF signal 126. The data sent between reader 110 and tag 120 may be represented by symbols, also known as RFID symbols. A symbol may be a delimiter, a calibration value, or implemented to represent binary data, such as “0” and “1”, if desired. Upon processing by reader 110 and tag 120, symbols may be treated as values, numbers, or any other suitable data representations.

The RF waveforms transmitted by reader 110 and/or tag 120 may be in a suitable range of frequencies, such as those near 900 MHz, 13.56 MHz, or similar. In some embodiments, RF signals 112 and/or 126 may include non-propagating RF signals, such as reactive near-field signals or similar. RFID tag 120 may be active or battery-assisted (i.e., possessing its own power source), or passive. In the latter case, RFID tag 120 may harvest power from RF signal 112.

FIG. 2 is a diagram of an RFID tag 220, which may function as tag 120 of FIG. 1. Tag 220 may be formed on a substantially planar inlay 222, which can be made in any suitable way. Tag 220 includes a circuit which may be implemented as an IC 224. In some embodiments IC 224 is fabricated in complementary metal-oxide semiconductor (CMOS) technology. In other embodiments IC 224 may be fabricated in other technologies such as bipolar junction transistor (BJT) technology, metal-semiconductor field-effect transistor (MESFET) technology, and others as will be well known to those skilled in the art. IC 224 is arranged on inlay 222.

Tag 220 also includes an antenna for transmitting and/or interacting with RF signals. In some embodiments the antenna can be etched, deposited, and/or printed metal on inlay 222; conductive thread formed with or without inlay 222; nonmetallic conductive (such as graphene) patterning on inlay 222; a first antenna coupled inductively, capacitively, or galvanically to a second antenna; or can be fabricated in myriad other ways that exist for forming antennas to receive RF waves. In some embodiments the antenna may even be formed in IC 224. Regardless of the antenna type, IC 224 is electrically coupled to the antenna via suitable IC contacts (not shown in FIG. 2). The term “electrically coupled” as used herein may mean a direct electrical connection, or it may mean a connection that includes one or more intervening circuit blocks, elements, or devices. The “electrical” part of the term “electrically coupled” as used in this document shall mean a coupling that is one or more of ohmic/galvanic, capacitive, and/or inductive. Similarly, the terms “electrically isolated” or “electrically decoupled” as used herein mean that electrical coupling of one or more types (e.g., galvanic, capacitive, and/or inductive) is not present, at least to the extent possible. For example, elements that are electrically isolated from each other are galvanically isolated from each other, capacitively isolated from each other, and/or inductively isolated from each other. Of course, electrically isolated components will generally have some unavoidable stray capacitive or inductive coupling between them, but the intent of the isolation is to minimize this stray coupling when compared with an electrically coupled path.

IC 224 is shown with a single antenna port, comprising two IC contacts electrically coupled to two antenna segments 226 and 228 which are shown here forming a dipole. Many other embodiments are possible using any number of ports, contacts, antennas, and/or antenna segments. Antenna segments 226 and 228 are depicted as separate from IC 224, but in other embodiments the antenna segments may alternatively be formed on IC 224. Tag antennas according to embodiments may be designed in any form and are not limited to dipoles. For example, the tag antenna may be a patch, a slot, a loop, a coil, a horn, a spiral, a monopole, microstrip, stripline, or any other suitable antenna.

Diagram 250 depicts top and side views of tag 252, formed using a strap. Tag 252 differs from tag 220 in that it includes a substantially planar strap substrate 254 having strap contacts 256 and 258. IC 224 is mounted on strap substrate 254 such that the IC contacts on IC 224 electrically couple to strap contacts 256 and 258 via suitable connections (not shown). Strap substrate 254 is then placed on inlay 222 such that strap contacts 256 and 258 electrically couple to antenna segments 226 and 228. Strap substrate 254 may be affixed to inlay 222 via pressing, an interface layer, one or more adhesives, or any other suitable means.

Diagram 260 depicts a side view of an alternative way to place strap substrate 254 onto inlay 222. Instead of strap substrate 254's surface, including strap contacts 256/258, facing the surface of inlay 222, strap substrate 254 is placed with its strap contacts 256/258 facing away from the surface of inlay 222. Strap contacts 256/258 can then be either capacitively coupled to antenna segments 226/228 through strap substrate 254, or conductively coupled using a through-via which may be formed by crimping strap contacts 256/258 to antenna segments 226/228. In some embodiments, the positions of strap substrate 254 and inlay 222 may be reversed, with strap substrate 254 mounted beneath inlay 222 and strap contacts 256/258 electrically coupled to antenna segments 226/228 through inlay 222. Of course, in yet other embodiments strap contacts 256/258 may electrically couple to antenna segments 226/228 through both inlay 222 and strap substrate 254.

In operation, the antenna couples with RF signals in the environment and propagates the signals to IC 224, which may both harvest power and respond if appropriate, based on the incoming signals and the IC's internal state. If IC 224 uses backscatter modulation then it may generate a response signal (e.g., signal 126) from an RF signal in the environment (e.g., signal 112) by modulating the antenna's reflectance. Electrically coupling and uncoupling the IC contacts of IC 224 can modulate the antenna's reflectance, as can varying the admittance or impedance of a shunt-connected or series-connected circuit element which is coupled to the IC contacts. If IC 224 is capable of transmitting signals (e.g., has its own power source, is coupled to an external power source, and/or can harvest sufficient power to transmit signals), then IC 224 may respond by transmitting response signal 126. In the embodiments of FIG. 2, antenna segments 226 and 228 are separate from IC 224. In other embodiments, the antenna segments may alternatively be formed on IC 224.

An RFID tag such as tag 220 is often attached to or associated with an individual item or the item packaging. An RFID tag may be fabricated and then attached to the item or packaging, may be partly fabricated before attachment to the item or packaging and then completely fabricated upon attachment to the item or packaging, or the manufacturing process of the item or packaging may include the fabrication of the RFID tag. In some embodiments, the RFID tag may be integrated into the item or packaging. In this case, portions of the item or packaging may serve as tag components. For example, conductive item or packaging portions may serve as tag antenna segments or contacts. Nonconductive item or packaging portions may serve as tag substrates or inlays. If the item or packaging includes integrated circuits or other circuitry, some portion of the circuitry may be configured to operate as part or all of an RFID tag IC. Thus, an “RFID IC” need not be distinct from an item, but more generally refers to the item containing an RFID IC and antenna capable of interacting with RF waves and receiving and responding to RFID signals. Because the boundaries between IC, tag, and item are thus often blurred, the terms “RFID IC”, “RFID tag”, “tag”, “radio IC”, “radio tag IC”, or “tag IC” as used herein may refer to the IC, the tag, or even to the item as long as the referenced element is capable of RFID functionality.

The components of the RFID system of FIG. 1 may communicate with each other in any number of modes. One such mode is called full duplex, where both reader 110 and tag 120 can transmit at the same time. In some embodiments, RFID system 100 may be capable of full duplex communication. Another such mode, which may be more suitable for passive tags, is called half-duplex, and is described below.

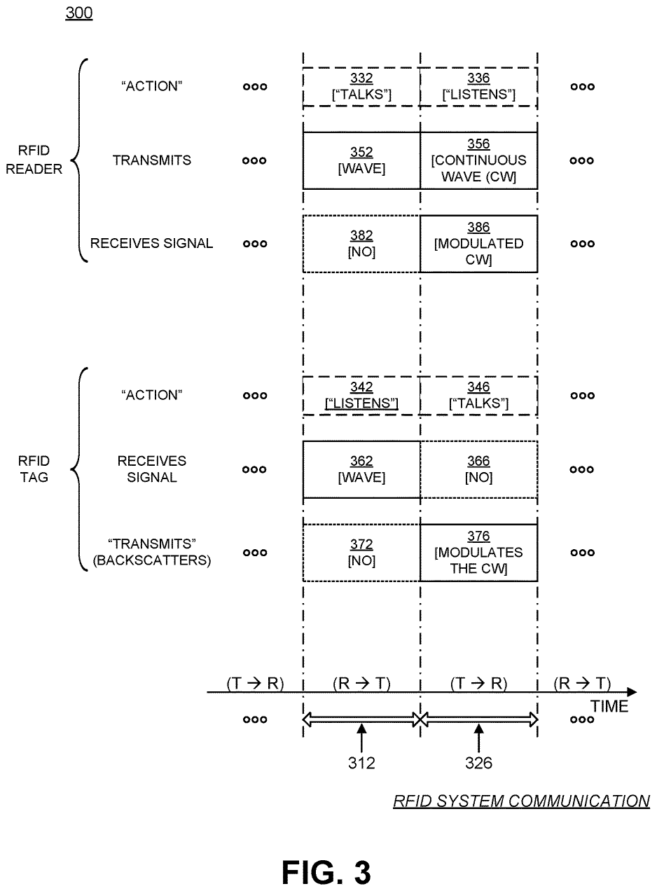

FIG. 3 is a conceptual diagram 300 for explaining half-duplex communications between the components of the RFID system of FIG. 1, in this case with tag 120 implemented as a passive tag. The explanation is made with reference to a TIME axis, and also to a human metaphor of “talking” and “listening”. The actual technical implementations for “talking” and “listening” are now described.

In a half-duplex communication mode, RFID reader 110 and RFID tag 120 talk and listen to each other by taking turns. As seen on axis TIME, reader 110 talks to tag 120 during intervals designated “R→T”, and tag 120 talks to reader 110 during intervals designated “T→R”. For example, a sample R→T interval occurs during time interval 312, during which reader 110 talks (block 332) and tag 120 listens (block 342). A following sample T→R interval occurs during time interval 326, during which reader 110 listens (block 336) and tag 120 talks (block 346). Interval 312 may be of a different duration than interval 326—here the durations are shown approximately equal only for purposes of illustration.

During interval 312, reader 110 transmits a signal such as signal 112 described in FIG. 1 (block 352), while tag 120 receives the reader signal (block 362), processes the reader signal to extract data, and harvests power from the reader signal. While receiving the reader signal, tag 120 does not backscatter (block 372), and therefore reader 110 does not receive a signal from tag 120 (block 382).

During interval 326, also known as a backscatter time interval or backscatter interval, reader 110 does not transmit a data-bearing signal. Instead, reader 110 transmits a continuous wave (CW) signal, which is a carrier that generally does not encode information. The CW signal provides energy for tag 120 to harvest as well as a waveform that tag 120 can modulate to form a backscatter response signal. Accordingly, during interval 326 tag 120 is not receiving a signal with encoded information (block 366) and instead modulates the CW signal (block 376) to generate a backscatter signal such as signal 126 described in FIG. 2. Tag 120 may modulate the CW signal to generate a backscatter signal by adjusting its antenna reflectance, as described above. Reader 110 then receives and processes the backscatter signal (block 386).

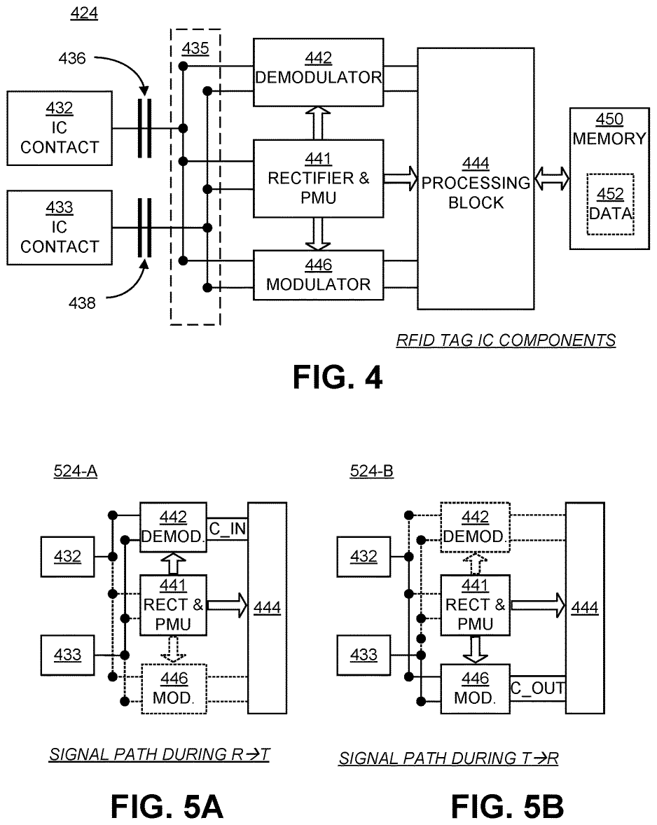

FIG. 4 is a block diagram showing a detail of an RFID IC, such as IC 224 in FIG. 2. Electrical circuit 424 may be implemented in an IC, such as IC 224. Circuit 424 implements at least two IC contacts 432 and 433, suitable for coupling to antenna segments such as antenna segments 226/228 in FIG. 2. When two IC contacts form the signal input from and signal return to an antenna they are often referred-to as an antenna port. IC contacts 432 and 433 may be made in any suitable way, such as from electrically-conductive pads, bumps, or similar. In some embodiments circuit 424 implements more than two IC contacts, especially when configured with multiple antenna ports and/or to couple to multiple antennas.

Circuit 424 includes signal-routing section 435 which may include signal wiring, signal-routing busses, receive/transmit switches, and similar that can route signals between the components of circuit 424. IC contacts 432/433 may couple galvanically, capacitively, and/or inductively to signal-routing section 435. For example, optional capacitors 436 and/or 438 may capacitively couple IC contacts 432/433 to signal-routing section 435, thereby galvanically decoupling IC contacts 432/433 from signal-routing section 435 and other components of circuit 424.

Capacitive coupling (and the resultant galvanic decoupling) between IC contacts 432 and/or 433 and components of circuit 424 is desirable in certain situations. For example, in some RFID tag embodiments IC contacts 432 and 433 may galvanically connect to terminals of a tuning loop on the tag. In these embodiments, galvanically decoupling IC contact 432 from IC contact 433 may prevent the formation of a DC short circuit between the IC contacts through the tuning loop.

Capacitors 436/438 may be implemented within circuit 424 and/or partly or completely external to circuit 424. For example, a dielectric or insulating layer on the surface of the IC containing circuit 424 may serve as the dielectric in capacitor 436 and/or capacitor 438. As another example, a dielectric or insulating layer on the surface of a tag substrate (e.g., inlay 222 or strap substrate 254) may serve as the dielectric in capacitors 436/438. Metallic or conductive layers positioned on both sides of the dielectric layer (i.e., between the dielectric layer and the IC and between the dielectric layer and the tag substrate) may then serve as terminals of the capacitors 436/438. The conductive layers may include IC contacts (e.g., IC contacts 432/433), antenna segments (e.g., antenna segments 226/228), or any other suitable conductive layers.

Circuit 424 includes a rectifier and PMU (Power Management Unit) 441 that harvests energy from the RF signal incident on antenna segments 226/228 to power the circuits of IC 424 during either or both reader-to-tag (R→T) and tag-to-reader (T→R) intervals. Rectifier and PMU 441 may be implemented in any way known in the art, and may include one or more components configured to convert an alternating-current (AC) or time-varying signal into a direct-current (DC) or substantially time-invariant signal.

Circuit 424 also includes a demodulator 442, a processing block 444, a memory 450, and a modulator 446. Demodulator 442 demodulates the RF signal received via IC contacts 432/433, and may be implemented in any suitable way, for example using a slicer, an amplifier, and other similar components. Processing block 444 receives the output from demodulator 442, performs operations such as command decoding, memory interfacing, and other related operations, and may generate an output signal for transmission. Processing block 444 may be implemented in any suitable way, for example by combinations of one or more of a processor, memory, decoder, encoder, and other similar components. Memory 450 stores data 452, and may be at least partly implemented as permanent or semi-permanent memory such as nonvolatile memory (NVM), EEPROM, ROM, or other memory types configured to retain data 452 even when circuit 424 does not have power. Processing block 444 may be configured to read data from and/or write data to memory 450.

Modulator 446 generates a modulated signal from the output signal generated by processing block 444. In one embodiment, modulator 446 generates the modulated signal by driving the load presented by antenna segment(s) coupled to IC contacts 432/433 to form a backscatter signal as described above. In another embodiment, modulator 446 includes and/or uses a transmitter to generate and transmit the modulated signal via antenna segment(s) coupled to IC contacts 432/433. Modulator 446 may be implemented in any suitable way, for example using a switch, driver, amplifier, and other similar components. Demodulator 442 and modulator 446 may be separate components, combined in a single transceiver circuit, and/or part of processing block 444.

In some embodiments, particularly in those with more than one antenna port, circuit 424 may contain multiple demodulators, rectifiers, PMUs, modulators, processing blocks, and/or memories.

FIG. 5A shows version 524-A of components of circuit 424 of FIG. 4, further modified to emphasize a signal operation during a R→T interval (e.g., time interval 312 of FIG. 3). During the R→T interval, demodulator 442 demodulates an RF signal received from IC contacts 432/433. The demodulated signal is provided to processing block 444 as C_IN, which in some embodiments may include a received stream of symbols. Rectifier and PMU 441 may be active, for example harvesting power from an incident RF waveform and providing power to demodulator 442, processing block 444, and other circuit components. During the R→T interval, modulator 446 is not actively modulating a signal, and in fact may be decoupled from the RF signal. For example, signal routing section 435 may be configured to decouple modulator 446 from the RF signal, or an impedance of modulator 446 may be adjusted to decouple it from the RF signal.

FIG. 5B shows version 524-B of components of circuit 424 of FIG. 4, further modified to emphasize a signal operation during a T→R interval (e.g., time interval 326 of FIG. 3). During the T→R interval, processing block 444 outputs a signal C_OUT, which may include a stream of symbols for transmission. Modulator 446 then generates a modulated signal from C_OUT and sends the modulated signal via antenna segment(s) coupled to IC contacts 432/433, as described above. During the T→R interval, rectifier and PMU 441 may be active, while demodulator 442 may not be actively demodulating a signal. In some embodiments, demodulator 442 may be decoupled from the RF signal during the T→R interval. For example, signal routing section 435 may be configured to decouple demodulator 442 from the RF signal, or an impedance of demodulator 442 may be adjusted to decouple it from the RF signal.

In typical embodiments, demodulator 442 and modulator 446 are operable to demodulate and modulate signals according to a protocol, such as the Gen2 Protocol mentioned above. In embodiments where circuit 424 includes multiple demodulators modulators, and/or processing blocks, each may be configured to support different protocols or different sets of protocols. A protocol specifies, in part, symbol encodings, and may include a set of modulations, rates, timings, or any other parameter associated with data communications. A protocol can be a variant of an internationally ratified protocol such as the Gen2 Protocol, for example including fewer or additional commands than the ratified protocol calls for, and so on. In some instances, additional commands may sometimes be called custom commands.

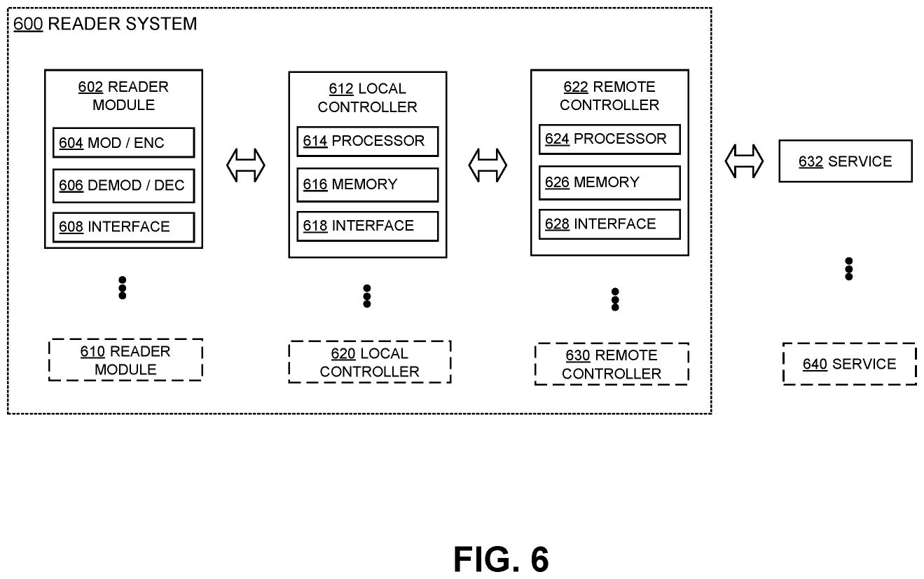

FIG. 6 depicts an RFID reader system 600 according to embodiments. Reader system 600 is configured to communicate with RFID tags and optionally to communicate with entities external to reader system 600, such as a service 632. Reader system 600 includes at least one reader module 602, configured to transmit signals to and receive signals from RFID tags. Reader system 600 further includes at least one local controller 612, and in some embodiments includes at least one remote controller 622. Controllers 612 and/or 622 are configured to control the operation of reader module 602, process data received from RFID tags communicating through reader module 602, communicate with external entities such as service 632, and otherwise control the operation of reader system 600.

In some embodiments, reader system 600 may include multiple reader modules, local controllers, and/or remote controllers. For example, reader system 600 may include at least one other reader module 610, at least one other local controller 620, and/or at least one other remote controller 630. A single reader module may communicate with multiple local and/or remote controllers, a single local controller may communicate with multiple reader modules and/or remote controllers, and a single remote controller may communicate with multiple reader modules and/or local controllers. Similarly, reader system 600 may be configured to communicate with multiple external entities, such as other reader systems (not depicted) and multiple services (for example, services 632 and 640).

Reader module 602 includes a modulator/encoder block 604, a demodulator/decoder block 606, and an interface block 608. Modulator/encoder block 604 may encode and modulate data for transmission to RFID tags. Demodulator/decoder block 606 may demodulate and decode signals received from RFID tags to recover data sent from the tags. The modulation, encoding, demodulation, and decoding may be performed according to a protocol or specification, such as the Gen2 Protocol. Reader module 602 may use interface block 608 to communicate with local controller 612 and/or remote controller 622, for example to exchange tag data, receive instructions or commands, or to exchange other relevant information.

Reader module 602 and blocks 604/606 are coupled to one or more antennas and/or antenna drivers (not depicted), for transmitting and receiving RF signals. In some embodiments, reader module 602 is coupled to multiple antennas and/or antenna drivers. In these embodiments, reader module 602 may transmit and/or receive RF signals on the different antennas in any suitable scheme. For example, reader module 602 may switch between different antennas to transmit and receive RF signals, transmit on one antenna but receive on another antenna, or transmit and/or receive on multiple antennas simultaneously. In some embodiments, reader module 602 may be coupled to one or more phased-array or synthesized-beam antennas whose beams can be generated and/or steered, for example by reader module 602, local controller 612, and/or remote controller 622.

Modulator/encoder block 604 and/or demodulator/decoder block 606 may be configured to perform conversion between analog and digital signals. For example, modulator/encoder block 604 may convert a digital signal received via interface block 608 to an analog signal for subsequent transmission, and demodulator/decoder block 606 may convert a received analog signal to a digital signal for transmission via interface block 608.

Local controller 612 includes a processor block 614, a memory 616, and an interface 618. Remote controller 622 includes a processor block 624, a memory 626, and an interface 628. Local controller 612 differs from remote controller 622 in that local controller 612 is collocated or at least physically near reader module 602, whereas remote controller 622 is not physically near reader module 602.

Processor blocks 614 and/or 624 may be configured to, alone or in combination, provide different functions. Such functions may include the control of other components, such as memory, interface blocks, reader modules, and similar; communication with other components such as reader module 620, other reader systems, services 632/640, and similar; data-processing or algorithmic processing such as encryption, decryption, authentication, and similar; or any other suitable function. In some embodiments, processor blocks 614/624 may be configured to convert analog signals to digital signals or vice-versa, as described above in relation to blocks 604/606; processor blocks 614/624 may also be configured to perform any suitable analog signal processing or digital signal processing, such as filtering, carrier cancellation, noise determination, and similar.

Processor blocks 614/624 may be configured to provide functions by execution of instructions or applications, which may be retrieved from memory (for example, memory 616 and/or 626) or received from some other entity. Processor blocks 614/624 may be implemented in any suitable way. For example, processor blocks 614/624 may be implemented using digital and/or analog processors such as microprocessors and digital-signal processors (DSPs); controllers such as microcontrollers; software running in a machine such as a general purpose computer; programmable circuits such as field programmable gate arrays (FPGAs), field-programmable analog arrays (FPAAs), programmable logic devices (PLDs), application specific integrated circuits (ASIC), any combination of one or more of these; and equivalents.

Memories 616/626 are configured to store information, and may be implemented in any suitable way, such as the memory types described above, any combination thereof, or any other known memory or information storage technology. Memories 616/626 may be implemented as part of their associated processor blocks (e.g., processor blocks 614/624) or separately. Memories 616/626 may store instructions, programs, or applications for processor blocks 614/624 to execute. Memories 616/626 may also store other data, such as files, media, component configurations or settings, etc.

In some embodiments, memories 616/626 store tag data. Tag data may be data read from tags, data to be written to tags, and/or data associated with tags or tagged items. Tag data may include identifiers for tags such as electronic product codes (EPCs), tag identifiers (TIDs), or any other information suitable for identifying individual tags. Tag data may also include tag passwords, tag profiles, tag cryptographic keys (secret or public), tag key generation algorithms, and any other suitable information about tags or items associated with tags.

Memories 616/626 may also store information about how reader system 600 is to operate. For example, memories 616/626 may store information about algorithms for encoding commands for tags, algorithms for decoding signals from tags, communication and antenna operating modes, encryption/authentication algorithms, tag location and tracking algorithms, cryptographic keys and key pairs (such as public/private key pairs) associated with reader system 600 and/or other entities, electronic signatures, and similar.

Interface blocks 608, 618, and 628 are configured to communicate with each other and with other suitably configured interfaces. The communications between interface blocks occur via the exchange of signals containing data, instructions, commands, or any other suitable information. For example, interface block 608 may receive data to be written to tags, information about the operation of reader module 602 and its constituent components, and similar, and may send data read from tags. Interface blocks 618 and 628 may send and receive tag data, information about the operation of other components, other information for enabling local controller 612 and remote controller 622 to operate in conjunction, and similar. Interface blocks 608/618/628 may also communicate with external entities, such as services 632, 640, other services, and/or other reader systems.

Interface blocks 608/618/628 may communicate using any suitable wired or wireless means. For example, interface blocks 608/618/628 may communicate over circuit traces or interconnects, or other physical wires or cables, and/or using any suitable wireless signal propagation technique. In some embodiments, interface blocks 608/618/628 may communicate via an electronic communications network, such as a local area network (LAN), a metropolitan area network (MAN), a wide area network (WAN), a network of networks such as the internet. Communications from interface blocks 608/618/628 may be secured, for example via encryption and other electronic means, or may be unsecured.

Reader system 600 may be implemented in any suitable way. One or more of the components in reader system 600 may be implemented as integrated circuits using CMOS technology, BJT technology, MESFET technology, and/or any other suitable physical implementation technology. Components may also be implemented as software executing on general-purpose or application-specific hardware.

In one embodiment, a “reader” as used in this disclosure may include at least one reader module like reader module 602 and at least one local controller such as local controller 612. Such a reader may or may not include any remote controllers such as remote controller 622. A reader including a reader module and a local controller may be implemented as a standalone device or as a component in another device. In some embodiments, a reader may be implemented as a mobile device, such as a handheld reader, or as a component in a mobile device such as a laptop, tablet, smartphone, wearable device, or any other suitable mobile device.

Remote controller 622, if not included in a reader, may be implemented separately. For example, remote controller 622 may be implemented as a local host, a remote server, or a database, coupled to one or more readers via one or more communications networks. In some embodiments, remote controller 622 may be implemented as an application executing on a cloud or at a datacenter.

Functionality within reader system 600 may be distributed in any suitable way. For example, the encoding and/or decoding functionalities of blocks 604 and 606 may be performed by processor blocks 614 and/or 624. In some embodiments, processor blocks 614 and 624 may cooperate to execute an application or perform some functionality. One of local controller 612 and remote controller 622 may not implement memory, with the other controller providing memory.

Reader system 600 may communicate with at least one service 632. Service 632 provides one or more features, functions, and/or capabilities associated with one or more entities, such as reader systems, tags, tagged items, and similar. Such features, functions, and/or capabilities may include the provision of information associated with the entity, such as warranty information, repair/replacement information, upgrade/update information, and similar; and the provision of services associated with the entity, such as storage and/or access of entity-related data, location tracking for the entity, entity security services (e.g., authentication of the entity), entity privacy services (e.g., who is allowed access to what information about the entity), and similar. Service 632 may be separate from reader system 600, and the two may communicate via one or more networks.

In some embodiments, an RFID reader or reader system implements the functions and features described above at least partly in the form of firmware, software, or a combination, such as hardware or device drivers, an operating system, applications, and the like. In some embodiments, interfaces to the various firmware and/or software components may be provided. Such interfaces may include application programming interfaces (APIs), libraries, user interfaces (graphical and otherwise), or any other suitable interface. The firmware, software, and/or interfaces may be implemented via one or more processor blocks, such as processor blocks 614/624. In some embodiments, at least some of the reader or reader system functions and features can be provided as a service, for example, via service 632 or service 640.

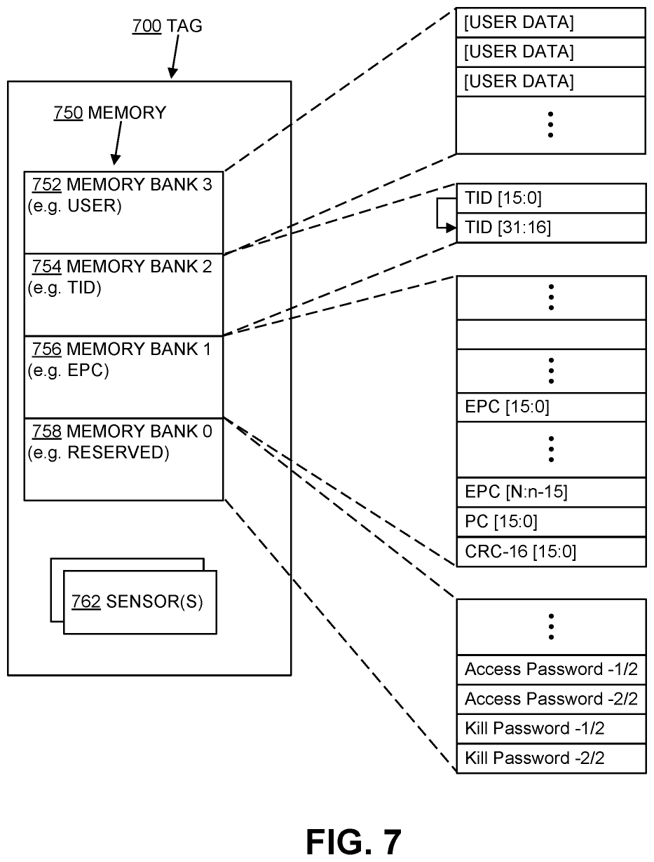

FIG. 7 is a diagram of an example RFID tag IC memory configuration, according to embodiments. Diagram 700 depicts an RFID tag IC memory 750, similar to the physical memory configuration described in the Gen2 Protocol. Memory 750 includes four partitions or sections 752, 754, 756, and 758. Partition 752 (“user memory”) may be configured to store user data. Partition 754 (“TID memory”) may be configured to store an identifier for the tag IC itself, such as a tag identifier or TID. In some cases, the TID may include a mask designer identifier (MDID) identifying a manufacturer of the tag IC. Partition 756 (“EPC memory”) may be configured to store an identifier for an item associated with or attached to the tag IC, such as an electronic product code or EPC. Partition 758 (“Reserved memory”) may be configured to store information reserved for the tag IC itself or otherwise not necessarily publicly accessible, such as passwords, PINs, cryptographic keys, or similar. The Gen2 Protocol specifies that two passwords, the Access password and the Kill password, can be stored in partition 758. The Access password, if present, can be used to restrict certain tag IC operations as described in the Gen2 Protocol. The Kill password, if present, can be used to cause a tag IC to enter the Killed state as described in the Gen2 Protocol. As these passwords are sensitive, partition 758 is generally not publicly accessible.

The configuration of tag IC memory 750 is provided as an example. Tag IC memory can have any number of partitions configured to store any suitable information. Tag IC memories are generally implemented using nonvolatile memory, although in some examples volatile memory may be used to implement tag IC memory.

A protocol, such as the Gen2 Protocol, can establish a specific set of features or capabilities that a tag IC should have in order for the tag IC to be compliant with the protocol. The specification of the Gen2 Protocol establishes several requirements, guiding both hardware and software features that tag ICs should include to be considered compliant with the Gen2 Protocol. A manufacturer of tag ICs may refer to such a protocol to guide its manufacturing process, ensuring that its manufactured tags can meet the requirements established by the protocol.

Often, as is the case with the Gen2 Protocol, a protocol leaves space for manufacturers to include optional, or extra, features and capabilities. For example, the Gen2 Protocol establishes that compliant tag ICs should be able to appropriately process and respond to all mandatory commands (e.g., Select, Query, ACK, Read, etc.) but it also includes several optional commands (e.g., Challenge, Access, etc.) that are not necessary for compliant tag ICs to implement. Further, some manufacturers may choose to include additional features or capabilities, not necessarily specified by any protocols, into their tag ICs. It may be useful for a reader to know the features and capabilities of any tag IC that it communicates with. If a manufacturer only manufactures one type of tag IC, then identifying the manufacturer of a tag IC can be synonymous with identifying all of the features and capabilities of the tag IC. However, manufacturers often manufacture several different types of tag ICs, such as a basic tag IC (e.g., a tag IC that only implements mandatory protocol features) and a feature-rich tag IC (e.g., a tag IC that implements additional features above and beyond mandatory protocol features). If both the basic tag IC and the feature-rich tag IC have a common set of features, then identifying the manufacturer of a tag IC can identify at least some of the features of the tag IC (e.g., the common set of features). In some examples, additional information can be combined with the identification of the manufacturer to discern the type of tag IC (i.e., if a tag IC is a basic tag IC or a feature-rich tag IC).

A reader may identify a tag IC's manufacturer using mandatory commands of the Gen2 Protocol. For example, a reader can initiate an inventory round by broadcasting an inventorying command (e.g., a Query or Query-type command such as QueryX or Query Y). A tag IC may receive the inventorying command and participate in the inventory round by replying to the inventorying command with a collision-resolution (CR) code, which may include a 16-bit random or pseudorandom number generated by the tag IC and known as an RN16. After receiving the CR code, the reader may send an acknowledgement command (e.g., an ACK command) including the CR code to the tag IC. The tag IC may then respond with an identifier, such as its electronic product code (EPC). Once the reader has received the identifier, the reader may choose between inventorying another tag or reading additional data from the current tag's memory (e.g., using a Read command). For example, the reader may opt to read a tag identifier (TID) from the tag IC. As is described above, the TID may be stored in a tag IC's TID memory and includes a mask designer identifier (MDID) that identifies the tag IC manufacturer and could potentially be used to identify features of the tag IC. Aside from manufacturer identification, the TID may also store information about the features and capabilities of the tag IC.

The inventorying process described above allows a reader to identify a manufacturer or features of a tag. However, because the reader must transmit additional commands (e.g., at least a Read command) to read the current tag's memory, inventorying is slowed.

Modifications to how a tag IC replies during the inventorying process can be made to streamline the identification of tag IC manufacturers and/or features. For example, a tag IC may be configured to reply to an acknowledgement command with a combination of a first identifier (e.g., an EPC) and a second identifier (e.g., a TID). Some such implementations are described in commonly assigned U.S. Pat. No. 8,134,451. Replies with combined identifiers may allow a reader to elicit tag IC feature information without having to transmit additional commands, thereby reducing potential inventorying slowdown. However, these combined replies are also longer, which may also reduce inventorying speed, albeit not to the degree of having to transmit additional commands.

Furthermore, readers may have difficulty inventorying tag populations including tag ICs that support combined replies and tag ICs that do not support combined replies, because reply lengths may differ between successive tag ICs in an unpredictable way. This may be alleviated by inventorying the two different tag IC types separately, at the cost of slowing down the overall inventorying process.

In some examples, a tag IC may be configured to respond to inventorying commands with a special CR code. The special CR code is similar to the CR code mentioned above-for example, both may have the same length-but may be computed, via a special CR code generation process, based on some information about the tag IC. For example, a tag IC may generate a special CR code such that at least part of the special CR code is correlated to at least part of an identifier associated with the tag IC or to an item that the tag IC is attached to. “Correlated” means having a statistically significant relationship to or is a function of. “Uncorrelated” is the opposite of “correlated”, and means not having a statistically significant relationship to or is not a function of. The identifier could be an EPC, a TID, one or more portions of either of the foregoing, or any other suitable identifying information known to the tag IC. In some examples, the special CR code may also be correlated to some other tag IC data instead of, or in addition to, the identifier. In general, most if not all of the information correlating to the special CR code should either be provided to the reader by the tag IC or otherwise be known to the reader.

The special CR code, while generated to be correlated to some tag IC information, may also include some randomness. For example, at least a portion of the special CR code may include a random (or pseudorandom) number generated by the tag IC. The tag IC may generate the random number and include its entirety (if shorter than the special CR code) or a portion (if the same length as or longer than the special CR code) in the special CR code. The tag IC may also (or instead) compute a value based on at least part of the generated random number and include the computed value in the special CR code. For example, the tag IC may use the random number or random number portion as input to a known function to generate an output that is then included in the special CR code.

The degree of randomness in a CR code may be characterized as the CR code's “entropy.” The maximum theoretical entropy of an n-bit code is n bits of randomness or entropy, which occurs when every bit in the code is random. A special CR code that includes some randomness but is partly computed will necessarily have less entropy than a CR code of the same length but entirely random (or pseudorandom). For example, the maximum theoretical entropy of a 16-bit CR code is 16 bits of randomness. A 16-bit CR code with a 16-bit random number has the maximum theoretical entropy of 16 bits of entropy. In contrast, a 16-bit special CR code including (and computed based on), for example, an 8-bit random number only has 8 bits of entropy. Accordingly, this 16-bit special CR code has entropy less than the entropy of the 16-bit CR code with the 16-bit random number, which also happens to be the maximum theoretical entropy of a 16-bit CR code (i.e., 16 bits of randomness).

Although special CR codes will have less entropy than the maximum theoretical entropy, they may still be generated to meet certain randomness criteria. For example, the special CR code generation process may be configured such that the probability of generating a specific special CR code value is relatively uniformly distributed over a range of potential values. In other words, there may be a relatively equal probability to generate any specific special CR code value within the potential range of values for the special CR code, regardless of the specific special CR code value. However, the number of potential values of a special CR code with a certain length may be smaller than the number of potential values for a CR code of that certain length. In any case, the resulting special CR code may also be considered random or pseudorandom, albeit with less entropy than a random number having the same length. In other examples, generation processes may be configured to generate special CR codes having a skewed distribution, a clustered distribution, or to meet any other desired randomness criterion.

In some examples, a special CR code may also be based on at least a part of a preceding inventorying command. For example, a tag IC may be configured to reply with a CR code upon receiving an inventorying command. If the tag IC is configured to reply with a special CR code, it may generate the special CR code based on one or more parameters specified or indicated in the received inventorying command. For example, if the received inventorying command is a Gen2 Query command, the parameter may include one or more of a DR (TRcal divide ratio) value, M (cycles per symbol) value, TRext value, Sel value, Session value, Target value, Q value, or CRC value, all of which are described in the Gen2 Protocol. In some examples, the special CR code may be based on parameters specified or indicated in a command preceding the inventorying command, such as a selection or other broadcast command. The special CR code may also be based on parameters specified or indicated in two or more preceding commands.

As described above, a tag IC may be configured to generate a special CR code that both includes some randomness and is correlated to some information provided by the tag IC to a reader, provided by the reader to the tag IC, or that can otherwise be derived by the reader. The special CR code may (a) include at least part of the randomness/information, and/or (b) include one or more values computed based on at least part of the randomness/information. Any computed values may be provided to or computed by the special CR code generation process. The computations may be done using any suitable function, process, or algorithm, such as arithmetic (binary or otherwise), logical operations (e.g., XOR and the like), code calculations (e.g., calculating a cyclic redundancy check code), or similar. The special CR code generation process may form the special CR code from its constituents in any suitable manner, such as via concatenation, interleaving, or yet another function or algorithm that outputs the special CR code.

A tag IC may not always respond to inventorying commands with a special CR code. For example, a tag IC manufacturer can configure its tag ICs to have multiple operating states. In a first state, a tag IC may be configured to respond to an inventorying command with a CR code entirely composed of a random or pseudorandom number uncorrelated (or not configured to be correlated) with an identifier of the tag IC. In a second state, the tag IC may be configured to respond to an inventorying command with a special CR code as described above. The state of a tag IC may be determined by, or identified by, a flag or bit in a memory of the tag IC. For example, an unasserted flag may correspond to a tag IC operating in the first state and an asserted flag may correspond to the tag IC operating in the second state, or vice versa.

In some examples, the special CR code generation process may involve a non-derivable parameter that a reader cannot derive from anything sent by a tag IC in response to an inventorying command. For example, the generation algorithm may use one or more bits of data stored by the tag IC (e.g., bit(s) of its TID or other data stored in tag IC memory) to generate the special CR code. In such examples, the reader may assume a value of the non-derivable parameter to use in the generation algorithm. The reader may also use all possible values of the non-derivable parameter to generate all possible special CR codes, but such a process may be limited by the computing power of the reader depending on the number of possible values of the non-derivable parameter.

The process used to generate special CR codes may be known both to tag ICs configured to implement special CR codes and readers configured to identify special CR codes. When such a reader receives a CR code and an identifier or additional information from a tag IC (e.g., in response to a sequence of inventorying commands), the reader can use the received information and its knowledge of the generation process to determine whether the received CR code is a special CR code. For example, the reader may use the received information and any information it knows as inputs into the generation process to compute a result. If the result matches the received CR code, then the reader can determine that the received CR code is a special CR code. As another example, the reader may reverse the generation process and use the received CR code as input to the reversed generation process. If the output of the reversed generation process corresponds to the received information and any known information, then the reader can determine that the received CR code is a special CR code. In some examples, an application or other device coupled to the reader may perform or assist with some or all of these actions instead of the reader.

Tag IC manufacturers may configure their tag ICs with a special CR code generation process that is unique to the manufacturer. Further, manufacturers may configure different types of tag ICs to have different special CR code generation processes. In other examples, manufacturers may instead configure different types of tag ICs to use different non-derivable parameters in a manufacturer-wide special CR code generation process. Accordingly, when a reader successfully uses a special CR code generation process to determine that a CR code received from a tag IC is a special CR code, the reader can use information about the special CR code generation process to identify the tag IC manufacturer and/or features of the tag IC.

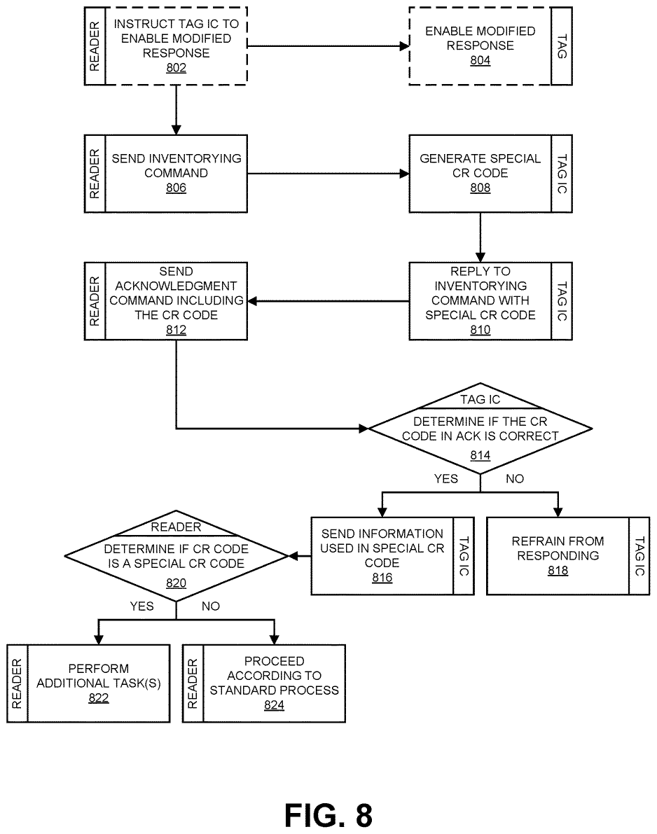

FIG. 8 is a process flow diagram of a reader inventorying a tag IC configured to modify its reply, according to embodiments. A special CR code generation algorithm may be known both by the reader and the tag IC.

At an optional step 802, the reader may instruct the tag IC to enable a modified reply. The reader may broadcast a certain command, referred to as a “modify reply command,” to instruct tag ICs that are configured with the appropriate functionality and that hear the command to modify their reply to a subsequent inventorying command by, for example, sending a special CR code. In some examples, a modify reply command can instruct tag ICs to modify their reply by targeting a specific memory location, such as a memory location of an identifier that is used in a special CR code generation process. Modify reply commands may otherwise instruct tag ICs to modify their reply based on information specified in the modify reply command, the structure of the modify reply command, transmission characteristics of the modify reply command, or otherwise. In one example, the modify reply command may be a Select command of the Gen2 Protocol. The Select command may point to a memory location (e.g., using MemBank, Pointer, and Length fields of the command) of an identifier that is used in the generation process for special CR codes. The Select command may or may not specify a value of the memory location (e.g., using a Mask field of the command), such that only tag ICs having identifiers matching the specified value at the specified memory location modify their reply. In other examples, the modify reply command may be implemented by other broadcast commands that do not request replies (e.g., a Gen2 Challenge command), inventorying commands that request replies, or any other command that can convey information to those tag ICs.

At an optional step 804, in response to receiving the modify reply command, the tag IC may enable a modified reply to inventorying commands. As an example, the tag IC may transition from a first state in which it responds to inventorying commands with a CR code including a random or pseudorandom number and uncorrelated with any tag IC information (e.g., an RN16 as described in the Gen2 Protocol) to a second state in which it replies with a special CR code correlated with at least some tag IC information. In some examples, the modify reply command may cause a modified reply flag or bit of the tag IC to be set to a value corresponding to the second state. In other examples, the modify reply command may itself specify the second state, for example, in the form of an included bit value.

In some examples, the tag IC may instead be configured to automatically respond with a modified reply, in which case the optional steps above are not needed. The tag IC may instead be configured to enable a modified reply in response to receiving any inventorying command requesting a CR code. In other examples, an inventorying command itself may serve as a “modify reply” command and cause a receiving tag IC to enable and reply with a modified reply. For example, an inventorying command may indicate that a modified reply flag is asserted or it may simply include an indication of a modified reply flag and a tag IC may cause itself to transition into the second state. Examples of such inventorying commands may include the Query, QueryRep, or QueryAdjust commands described by the Gen2 Protocol, or other similar commands. The tag IC may be configured to automatically modify its reply in response to receiving any command that initiates or specifies an inventorying round, or only to those that contain specific information or instructions to modify the tag reply.

At step 806, the reader may send an inventorying command to the tag IC. Examples of inventorying commands include Query-type commands such as a Query, QueryRep, QueryAdjust, and other similar commands. As described above, the inventorying command may itself serve as a modified reply command.

At step 808, in response to receiving the inventorying command, the tag IC, being in the second state, may use the generation algorithm to generate a special CR code. As described above, the special CR code may be based on some randomness (e.g., a random or pseudorandom number), one or more identifiers of the tag IC or portions thereof (e.g., a TID, an EPC, or portions thereof), data associated with the inventorying command (e.g., a session indicated by a query-type command), a parameter that a reader cannot derive from the special CR code or identifier(s), or any other suitable data accessible by the tag IC.

At step 810, after generating the special CR code, the tag IC may send the special CR code to the reader. The tag IC may retain the special CR code in at least semi-permanent memory.

At step 812, after receiving the special CR code, the reader may send an acknowledgement command including the received CR code to the tag IC. It should be noted that the reader may not know, at this point in the process, if the received CR code is a special CR code or not.

At step 814, after receiving the acknowledgement command, the tag IC may determine if the CR code received in the acknowledgement command is the same as the special CR code it sent at step 810.

At step 816, if the tag IC determines that the CR code in the acknowledgement command is the same as the special CR code it previously sent, the tag IC may send at least some of the information that was used in the generation of the special CR code, such as an identifier or identifier portion. For example, if the special CR code was generated based on some random value and an EPC of the tag IC, the tag IC may send at least part of the EPC to the reader. If the special CR code is based on more than one identifier, such as the EPC and a TID, the tag IC may only send one identifier or it may send both identifiers. If the special CR is based on any other information known to the tag IC, then the tag IC may or may not send the other information to the reader.

At step 818, if the tag IC determines that the CR code in the acknowledgement command is not the same as the special CR code it previously sent, the tag IC may refrain from responding to the acknowledgement command. In this instance, since the reader transmitted the special CR code in the acknowledgement command, issues associated with transmission or reception of the acknowledgement command (e.g., interference or corruption) may cause the tag IC to determine that the CR code in the acknowledgement command does not match the special CR code it previously sent.

At step 820, after receiving the information used to at least partially generate the special CR code, the reader may determine if the received CR code is a special CR code. The reader knows the generation algorithm that the tag IC used to generate the special CR code, has received information from the tag IC used to at least partially generate the special CR code, and may know at least some of the other inputs used to generate the special CR code. The reader may use the generation algorithm to generate the special CR code itself and it may compare the generated special CR code to the received special CR code. Alternatively, the reader may reverse the process used to generate the special CR code, use the received special CR code as input, and compare the output of the reversed special CR code generation process with known inputs that the tag has provided (e.g., the tag identifier sent in step 816 above).

In some examples, the special CR code may be generated based on inputs that the reader does not have knowledge of, such as another random or pseudorandom number, a non-derivable parameter, or otherwise. The generation process may be configured such that a correlation between a special CR code and an identifier can be determined even if other inputs to the generation process are not known. In some examples, the reader may assume a value for the inputs that are not known, and generate a special CR code using the assumed values. The reader may itself generate special CR codes for all possible values of the inputs to determine all possible special CR codes and determine if the received special CR code matches any of the generated special CR codes. This approach may take longer, depending on the number of possible values and on the computing power of the reader. The reader may instead offload the computation to another device with greater computing power. In some examples, the reader may know multiple, different generation processes, and generate a special CR code using each of the generation processes and determine that the received special CR code is a special CR code if any of the resultant generated special CR codes match the received special CR code.

Upon determining that the received CR code is a correctly formed special CR code correlated to the received identifier, at step 822 the reader may use the determination to perform one or more additional tasks. However, if the reader for some reason determines that the received CR code is not a special CR code, for example due to transmission or reception issues, then at step 824 the reader may proceed according to a standard process such as the Gen2 Protocol. If the reader expects to receive a special CR code, for example if the reader has previously communicated with the tag IC, but does not, then the reader may alert that the tag IC is malfunctioning or is otherwise not operating normally.

As described above, at step 822 the reader may use the determination that the received CR code is a correctly formed special CR code correlated to the received identifier to perform one or more additional tasks. For example, the reader may determine information about the tag IC, such as its manufacturer, its type, its features or capabilities, and/or where to find more information about the tag IC or associated item. The reader may determine this information in a number of ways.

It may be the case that only tag ICs from a certain manufacturer are enabled to send modified replies. If so, then the reader may use the fact that the tag IC was able to correctly generate a special CR code correlated to its identifier to identify that manufacturer. If the manufacturer only manufactures one type of tag IC with the modified reply capability, then the reader may further be able to identify the specific type of tag IC. The reader may have knowledge of the features of the specific type of tag IC. However, it may be the case that the manufacturer enables the functionality on several different types of tag ICs that they manufacture. If that is the case, then the reader may only be able to determine the manufacturer and at best determine a common set of features of tag ICs between all tag ICs having the modified reply functionality.

Another way in which the reader can determine information about the tag IC is based on the generation process used to generate the special CR code. Different manufacturers may choose to implement different special CR code generation processes. It may be the case that the reader knows the different generation processes used by different manufacturers, and at step 824 attempts to recreate a special CR code using each of the known generation processes. If one of the generation processes result in a special CR code matching the received special CR code, then the reader may identify a manufacturer associated with that generation process. In some examples, manufacturers may use different generation processes for different types of tag ICs, allowing the reader to identify the type of the tag IC.

Yet another method to determine information about the tag IC is based on whether the generation process includes an input that is particular to the tag IC, or to the type of that tag IC. For example, as described above, a tag IC may use a non-derivable parameter as a part of the special CR code generation process. The reader may use the same generation process, but different possible values of the non-derivable parameter to generate a number of possible special CR codes. The reader may identify the tag IC manufacturer, type, and/or features based on the value of the non-derivable parameter that was used to correctly generate the special CR code.

A correct special CR code, in addition to providing information about a tag IC's manufacturer, type, features, and/or capabilities, may also indicate where additional information about the tag IC or associated item can be found or who to contact for the additional information. For example, the information about a tag IC's manufacturer or type may also indicate where the additional information can be found, either directly or via knowledge of the manufacturer or IC type. In other examples, the identity of the generation process or algorithm used to generate the special CR code and/or one or more codes in the special CR code may also indicate where the additional information can be found. Indications of where the additional information can be found may take the form of a network location (e.g., a website or uniform resource locator [URL]), a company or entity identifier (which may identify an entity different than the tag IC manufacturer), or any other pointer or reference that an entity can use to seek the additional information.

As described above, a reader may be able to determine information about a tag IC, such as its manufacturer, type, features, capabilities, and/or where to find additional information about the tag IC or its associated item. The determined information may allow one or more additional tasks to be performed. For example, tag ICs from different manufacturers, or even different types of tag ICs from the same manufacturer, may implement additional features, capabilities, or functionalities. If the manufacturer and/or type of a tag IC is known, those additional features, capabilities, or functionalities can be used. One example task may include a reader identifying a tag IC configured by its manufacturer to respond to custom commands and upon identifying the tag IC, sending such a custom command to the tag IC. Another example task may include categorizing tag ICs within a population based on tag IC manufacturer and/or type without having to slow down inventorying by either accessing tag ICs or requiring tag ICs to reply with longer codes.

In some examples, certain applications or services may be restricted to certain types of tag ICs. For example, an application or service involving certain features, such as authentication, may be restricted to tag ICs that implement those features. In these examples, a first tag IC that does not implement special CR codes or a second tag IC that does implement special CR codes but does not implement a particular generation process for special CR codes, use certain information to generate special CR codes, or is of a certain type may both be considered inappropriate. In this situation, associated replies or requests may be ignored or rejected by the application or service. In some examples, a receiving reader may know the restrictions associated with an application or service, and upon receiving a reply from the first or second tag IC may not report it to the application or service. Further, the application, service or reader may optionally forward such a reply or request to another suitable application or service for reporting. In certain cases, if the application or service involves authentication of the tag IC or its associated item, such ignored/rejected replies or requests (e.g., those associated with tag ICs that do not implement a certain special CR code generation process, do not use certain information to generate special CR codes, and/or are not of a certain type) may be further considered counterfeit and optionally stored and reported to one or more relevant entities or authorities.

In some examples one or more other entities, instead of a reader, may determine whether a received CR code is a special CR code, identify a tag IC manufacturer and/or tag features based on the determination, and/or performing additional tasks based on the determination. These other entities may include another device coupled to the reader, an application executing on the reader or the other device, or a service coupled to the reader via, for example, a network interface. For example, the reader may send the determination of whether the received CR code is a special CR code to the entity, which may then perform the identification of tag IC manufacturer, identification of tag IC features, and/or additional tasks. As another example, the reader may send the received CR code and information to the entity, which then determines whether the received CR code is a special CR code.

According to some examples, a method for a radio integrated circuit having an identifier includes receiving an inventorying command. If the radio IC is in a first state, then the radio IC may respond to the inventorying command by sending a first reply including a first random number. The first reply may be uncorrelated with the identifier. If the radio IC is in a second state, then the radio IC may respond to the inventorying command by sending a second reply including a second random number. The second reply may be correlated with the identifier. The method may also include receiving an acknowledgement command including either the first or second reply, and responding to the acknowledgement command by sending the identifier.

According to other examples, the method may further include transitioning to either the first state or the second state in response to a value contained in the inventorying command. The method may yet further include receiving a broadcast command prior to receiving the inventorying command, and transitioning to either the first state or the second state in response to a value contained in the broadcast command. The identifier may be an IC identifier, an item identifier, or a number associated with the IC identifier or the item identifier. The second reply may be computed based on at least a portion of the identifier and one or more of: at least a portion of the second random number, and a portion of the inventorying command. A first entropy of the first reply may be greater than a second entropy of the second reply. The first entropy may be less than a maximum theoretical entropy of the first reply. In some examples, the first and second replies may have the same bit length. The second reply may meet a first randomness criterion.

According to further examples, a radio IC may be configured to operate in a first or second state. The radio IC may include a transceiver configured to receive commands and send replies. The radio IC may also include a memory that stores an identifier. The radio IC may further include a processing block that is coupled to the transceiver and to the memory. The processing block may be configured to receive, via the transceiver, an inventorying command. If the IC is in the first state, then the processing block may be configured to respond to the inventorying command by sending, via the transceiver, a first reply including a first random number. The first reply may be uncorrelated with the identifier. If the IC is in the second state, then the processing block may be configured to respond to the inventorying command by sending, via the transceiver, a second reply including a second random number. The second reply may be correlated with the identifier. The processing block may be further configured to receive, via the transceiver, an acknowledgment command including one of the first and second replies, and to respond to the acknowledgment command by sending, via the transceiver, the identifier.

According to other examples, the processing block may be further configured to cause the IC to transition to either the first state or the second state in response to a value contained in the inventorying command. The processing block may also be configured to receive, via the transceiver, a broadcast command prior to receiving the inventorying command and to cause the IC to transition to either the first state or the second state in response to a value contained in the broadcast command. The identifier may be an IC identifier, an item identifier, or a number associated with the IC identifier or the item identifier. The processing block may be further configured to compute the second reply based on at least a portion of the identifier and one or more of: at least a portion of the second random number, and a portion of the inventorying command. A first entropy of the first reply may be greater than a second entropy of the second reply. The first entropy may be less than a maximum theoretical entropy of the first reply. The first and second reply may have the same bit length. The second reply may meet a first randomness criterion.

According to yet further examples, a method for a radio frequency identification reader may include transmitting a request including an inventorying command and requesting a correct radio tag reply that includes a random number. A correct radio tag reply may be at least partly formed by a tag reply computation using a portion of an radio tag identifier and one or more of: at least a portion of the random number, and a portion of the inventorying command. The method may include receiving, from a radio tag, a reply and an identifier. The method may also include determining, using at least the tag reply computation and the received identifier, whether the received reply is correct. If the received reply is not correct, then the method can include at least one of: not reporting the radio tag to an application, and reporting the radio tag as inappropriate or counterfeit to the application.

According to other examples, the request further includes a broadcast command preceding the inventorying command. The request may request the correct radio tag reply by specifying a radio tag state. Determining whether the received reply is correct may include reversing the tag reply computation using at least the received reply and the received identifier to form a result, and comparing the result to at least the received reply and the received identifier. In other examples, determining whether the received reply is correct may include performing the tag reply computation using at least the received reply and the received identifier to form a result, and comparing the result to the received reply. The radio tag identifier may be one of an IC identifier, an item identifier, or a number associated with one of the IC identifier and the item identifier. The tag reply computation may use at least a portion of the radio tag identifier by using a cyclic redundancy check code that is computed over at least the portion of the radio tag identifier. In some examples, the method may further include, if the received reply is not correct, determining that the radio tag does not support the tag reply computation. A correct radio tag reply may have an entropy less than a maximum theoretical entropy of the radio tag reply.

According to additional examples, a radio frequency identification reader may include a transceiver configured to send commands and receive replies. The radio frequency identification reader may also include a processing block coupled to the transceiver. The processing block may be configured to transmit, via the receiver, a request including an inventorying command and requesting a correct RFID tag reply. A correct radio tag reply may include a random number, and may be at least partly formed by a tag reply computation using at least a portion of a radio tag identifier and one or more of: at least a portion of the random number, and a portion of the inventorying command. The processing block may be configured to receive, from a radio tag via the transceiver, a reply and an identifier. The processing block may be further configured to determine, using at least the tag reply computation and the received identifier, whether the received reply is correct. If the received reply is not correct, the processing block may be configured to, at least one of: not report the radio tag to an application, and report the radio tag as inappropriate or counterfeit to the application.

According to other examples, the request further includes a broadcast command preceding the inventorying command. The request may request the correct radio tag reply by specifying a radio tag state. The processing block may be configured to determine whether the received reply is correct by reversing the tag reply computation using at least the received reply and the received identifier to form a result, and comparing the result to at least the received reply and the received identifier. In other examples, the processing block may be configured to determine whether the received reply is correct by performing the tag reply computation using at least the received reply and the received identifier to form a result, and comparing the result to the received reply. The radio tag identifier may be one of an IC identifier, an item identifier, or a number associated with one of the IC identifier and the item identifier. The tag reply computation may use at least a portion of the radio tag identifier by using a cyclic redundancy check code that is computed over at least the portion of the radio tag identifier. In some examples, the processing block may be further configured to, if the received reply is not correct, determine that the radio tag does not support the tag reply computation. A correct radio tag reply may have an entropy less than a maximum theoretical entropy of the radio tag reply.

According to some examples, a method for a radio frequency identification reader to report radio tags that support collision resolution (CR) reply computation to an application includes transmitting a request including an inventorying command and requesting a CR reply. The method may also include receiving, from a radio tag, a CR reply and an identifier. The method may further include determining whether the CR reply is correlated with the identifier. If the CR reply is correlated with the identifier, the method may include reporting the radio tag to the application. If the CR reply is not correlated with the identifier, the method may include at least one of: reporting the radio tag as inappropriate or counterfeit to the application, and determining that the radio tag does not support the CR reply computation.

According to other examples, the CR reply may be computed based on at least a portion of the identifier. The CR reply may further be computed based on at least a portion of the second random number and a portion of the inventorying command. The identifier may be an IC identifier, an item identifier, or a number associated with the IC identifier or the item identifier. In some examples, determining whether the CR reply is correlated with the identifier includes reversing a computation used to generate the CR reply using at least the received CR reply and the received identifier to form a result, and comparing the result to at least the received CR reply and the identifier. In other examples, determining whether the CR reply is correlated with the identifier includes performing a computation using at least the received CR reply and the received identifier to form a result, and comparing the result to the received CR reply. The method may further include receiving a reply from the application. The reply may include one or more of a manufacturer of the radio tag, and a list of features of the radio tag. The reader may transmit a subsequent command based on the received manufacturer and/or list of features of the radio tag.

According to further examples, a radio frequency identification reader configured to report radio tags that support CR reply to an application may include a transceiver configured to send commands and receive replies. The radio frequency identification reader may also include a processing block coupled to the transceiver. The processing block may be configured to transmit, via the transceiver, a request including an inventorying command and requesting a CR reply. The processing block may be also be configured to receive, from a radio tag via the transceiver, a CR reply and an identifier. The processing block may be further configured to determine whether the CR reply is correlated with the identifier. If the CR reply is correlated with the identifier, the processing block may be configured to report the radio tag to the application. If the CR reply is not correlated with the identifier, the processing block may be configured to, at least one of: report the radio tag as inappropriate or counterfeit to the application, and determine that the radio tag does not support the CR reply computation.

As mentioned previously, embodiments are directed to identification of a manufacturer of a tag and one or more of its features. Embodiments additionally include programs, and methods of operation of the programs. A program is generally defined as a group of steps or operations leading to a desired result, due to the nature of the elements in the steps and their sequence. A program is usually advantageously implemented as a sequence of steps or operations for a processor but may be implemented in other processing elements such as FPGAs, DSPs, or other devices as described above.

Performing the steps, instructions, or operations of a program requires manipulating physical quantities. Usually, though not necessarily, these quantities may be transferred, combined, compared, and otherwise manipulated or processed according to the steps or instructions, and they may also be stored in a computer-readable medium. These quantities include, for example, electrical, magnetic, and electromagnetic charges or particles, states of matter, and in the more general case can include the states of any physical devices or elements. Information represented by the states of these quantities may be referred-to as bits, data bits, samples, values, symbols, characters, terms, numbers, or the like. However, these and similar terms are associated with and merely convenient labels applied to the appropriate physical quantities, individually or in groups.

Embodiments furthermore include storage media. Such media, individually or in combination with others, have stored thereon instructions, data, keys, signatures, and other data of a program made according to the embodiments. A storage medium according to embodiments is a computer-readable medium, such as a memory, and can be read by a processor of the type mentioned above. If a memory, it can be implemented in any of the ways and using any of the technologies described above.

Even though it is said that a program may be stored in a computer-readable medium, it does not need to be a single memory, or even a single machine. Various portions, modules or features of it may reside in separate memories, or even separate machines. The separate machines may be connected directly, or through a network such as a local access network (LAN) or a global network such as the Internet.

Often, for the sake of convenience only, it is desirable to implement and describe a program as software. The software can be unitary or thought of in terms of various interconnected distinct software modules.

The foregoing detailed description has set forth various embodiments of the devices and/or processes via the use of block diagrams and/or examples. Insofar as such block diagrams and/or examples contain one or more functions and/or aspects, each function and/or aspect within such block diagrams or examples may be implemented individually and/or collectively, by a wide range of hardware, software, firmware, or virtually any combination thereof. Some aspects of the embodiments disclosed herein, in whole or in part, may be equivalently implemented employing integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and/or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, configurations, tags, RFICs, readers, systems, and the like, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). Any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. All language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

1. A method for a radio integrated circuit (IC) having an identifier, the method comprising:
receiving an inventorying command;
if the radio IC is in a first state, then responding to the inventorying command by sending a first reply including a first random number, wherein the first reply is uncorrelated with the identifier;
if the radio IC is in a second state, then responding to the inventorying command by sending a second reply including a second random number, wherein the second reply is correlated with the identifier;
receiving an acknowledgement command including either the first or second reply; and
responding to the acknowledgement command by sending the identifier.

2. The method of claim 1. further comprising transitioning to either the first state or the second state in response to a value contained in the inventorying command.

3. The method of claim 1, further comprising:
receiving a broadcast command prior to receiving the inventorying command; and
transitioning to either the first state or the second state in response to a value contained in the broadcast command.

4. The method of claim 1, wherein the identifier is an IC identifier, an item identifier, or a number associated with the IC identifier of the item identifier.

5. The method of claim 4, further comprising computing the second reply based on at least a portion of the identifier and one or more of:
at least a portion of the second random number; and
a portion of the inventorying command.

6. The method of claim 1, wherein a first entropy of the first reply is greater than a second entropy of the second reply.

7. The method of claim 6, wherein the first entropy is less than a maximum theoretical entropy of the first reply.

8. The method of claim 1, wherein the first and second replies have the same bit length.

9. The method of claim 1, wherein the second reply meets a first randomness criterion.

10. A radio integrated circuit (IC) configured to respond to inventorying commands in a state-dependent way, the IC comprising:
a transceiver configured to receive commands and send replies;
a memory storing an identifier; and
a processing block coupled to the transceiver and the memory and configured to:
receive, via the transceiver, an inventoryving command:
if the radio IC is in a first state, then respond to the inventorving command by causing the transceiver to send a first reply including a first random number wherein the first reply is uncorrelated with the identifier:
if the radio IC is in a second state, then respond to the inventorving command by causing the transceiver to send a second reply including a second random number, wherein the second reply is correlated with the identifier:
receive, via the transceiver, an acknowledgement command including either the first or second reply; and
respond to the acknowledgement command by causing the transceiver to send the identifier.

11. The RFID IC of claim 10, wherein the processing block is further configured to:
cause the IC to transition to either the first state or the second state in response to a value contained in the inventorying command.

12. The RFID IC of claim 10, wherein the processing block is further configured to:
receive, via the transceiver, a broadcast command prior to the inventorying command; and
cause the IC to transition to either the first state or the second state in response to a value contained in the broadcast command.

13. The RFID IC of claim 10, wherein the identifier is an IC identifier, an item identifier, or a number associated with the IC identifier or the item identifier.

14. The RFID IC of claim 13, wherein the processing block is further configured to:
compute the second reply based on at least a portion of the identifier and one or more of:
at least a portion of the second random number; and
a portion of the inventorying command.

15. The RFID IC of claim 10, wherein a first entropy of the first reply is greater than a second entropy of the second reply.

16. The RFID IC of claim 15, wherein the first entropy is less than a maximum theoretical entropy of the first reply.

17. The RFID IC of claim 10, wherein the first and second replies have the same bit length.

18. The RFID IC of claim 10, wherein the second reply meets a first randomness criterion.

19. A radio integrated circuit (IC) configured to send different kinds of collision-resolution (CR) codes, the IC comprising:
a transceiver configured to receive commands and send replies;
a memory storing an identifier; and
a processing block coupled to the transceiver and the memory and configured to:
when the IC is in a first state, cause the transceiver to send CR codes that are uncorrelated with the identifier; and
when the IC is in a second state, cause the transceiver to send CR codes that are correlated with the identifier.

20. The radio IC of claim 19, wherein the processing block is further configured to compute the CR codes that are correlated with the identifier based on at least a portion of the identifier and one or more of a random number and a portion of a received inventorying command.
